(19) United States
(12) Patent Application Publication
(10) Pub. No.: US 2014/0144329 A1
(43) Pub. Date: May 29, 2014

(54) Bottle-Top Wine Decanter

(71) Applicant: YIE LIN TECHNOLOGY CO., LTD., Toufen Township (TW)

(72) Inventor: Jiou-Kwei Chiu, Taipei (TW)

(73) Assignee: YIE LIN TECHNOLOGY CO., LTD., TOUFEN TOWNSHIP (TW)

(21) Appl. No.: 13/688,419

(22) Filed: Nov. 29, 2012

(51) Int. Cl. C12H 1/02

(52) U.S. Cl. CPC C12H 1/02
USPC 99/277.1

(57) ABSTRACT

A bottle-top wine decanter includes a wine-pouring tube carrying therein alkaline filter components for filtering wine, a breathing tube, a cap holding the wine-pouring tube and the breathing tube in parallel, a stopper mounted in the cap for press-fitting into a bottleneck of a wine bottle, and a magnetizer for activating wine to make the wine easy to drink.

### BACKGROUND OF THE INVENTION

1. Field of the Invention

The present invention relates to a wind decanter and more particularly, to a bottle-top wine decanter attachable to a bottleneck of a bottle of wine for decanting the wine of a bottle when the user is pouring the wine out of the bottle into a glass for service.

2. Description of the Related Art

When pouring a glass of wine, the wine may be splashed out from the glass if the bottle is excessively tilted, causing unnecessary waste and trouble. To solve this problem, wine pourers are created. However, a wine pourer can simply make serving wine a dripless event. When serving wine, an extra wine decanter may be necessary. Therefore, there is a strong demand for an apparatus that can serve as a wine pourer as well as a wine decanter.

### SUMMARY OF THE INVENTION

The present invention has been accomplished under the circumstances in view. It is the main object of the present invention to provide a bottle-top wine decanter, which uses alkaline filter components to filtrate the wine, enhancing the quality of the wine tasting.

It is another object of the present invention to provide a bottle-top wine decanter, which works as a wine pourer, preventing splashing of the wine.

It is still another object of the present invention to provide a bottle-top wine decanter, which keeps a cap press-fitted onto a stopper, enhancing component parts positioning stability.

It is still another object of the present invention to provide a bottle-top wine decanter, which uses a magnetizer to activate the wine, making the wine easy to drink.

To achieve these and other objects of the present invention, a bottle-top wine decanter comprises a wine-pouring tube carrying therein alkaline filter components for filtering wine, a breathing tube, a cap holding the wine-pouring tube and the breathing tube in parallel, a stopper mounted in the cap for press-fitting into a bottleneck of a wine bottle, and a magnetizer for activating wine to make the wine easy to drink.

### BRIEF DESCRIPTION OF THE DRAWING

FIG. 1 is a cross-sectional view of a bottle-top wine decanter in accordance with the present invention.

FIG. 2 is a longitudinal sectional view of the bottle-top wine decanter in accordance with the present invention.

FIG. 3 is an exploded view of the bottle-top wine decanter in accordance with the present invention.

FIG. 4 is an elevational view of the bottle-top wine decanter in accordance with the present invention.

### DETAILED DESCRIPTION OF THE INVENTION

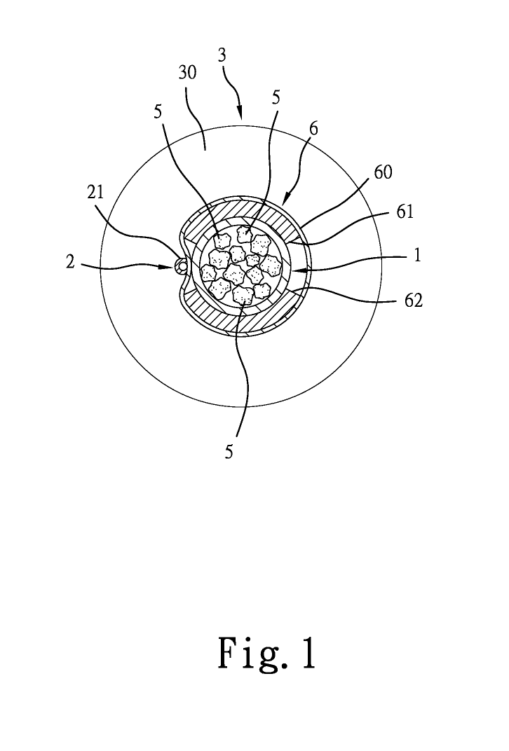

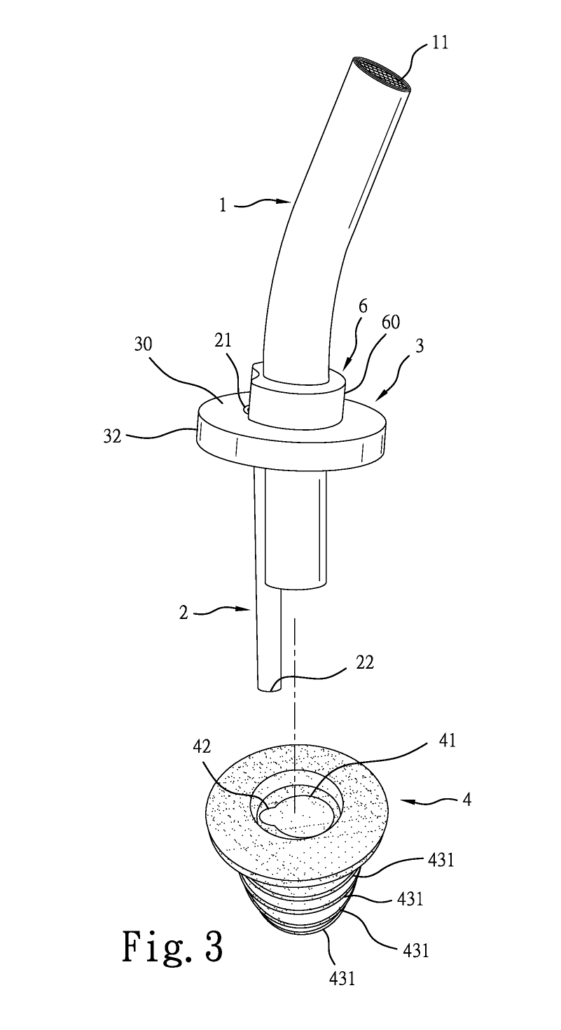

Referring to FIGS. 1-4, a bottle-top wine decanter in accordance with the present invention is shown for decanting and aerating the wine of a bottle when the user is pouring out the wine onto a glass for service. The bottle-top wine decanter comprises a wine-pouring tube 1, a breathing tube 2, a cap 3, and a stopper 4.

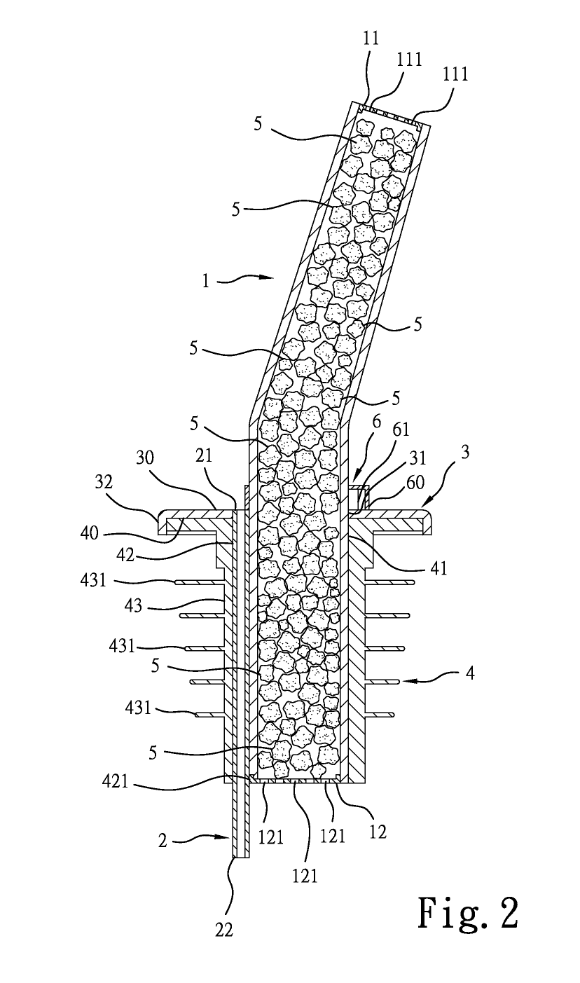

The wine-pouring tube 1 comprises a top wire mesh filter 11 and a bottom wire mesh filter 12 respectively and fixedly mounted in opposing top and bottom ends thereof, and a plurality of alkaline filter components 5 set therein between the top wire mesh filter 11 and the bottom wire mesh filter 12. The top wire mesh filter 11 and the bottom wire mesh filter 12 each define therein a plurality of open spaces 111 or 121 (see FIG. 2). Further, the alkaline filter components 5 can be selected from the group of alkaline ore, tourmaline and trace minerals.

The breathing tube 2 is peripherally bonded to the periphery of a lower part of the wine-pouring tube 1 and inserted with the wine-pouring tube 1 through the cap 3 and then fixedly secured with the wine-pouring tube 1 to the cap 3, keeping the bottom end 22 thereof suspending below the bottom edge of the wine-pouring tube 1 at a distance.

The cap 3 comprises a circular top wall 30, an insertion hole 31 cut through the top wall 30 for the mounting of the wine-pouring tube 1 and the breathing tube 2 in such a manner that the top end 21 of the breathing tube 2 can be exposed outside the top wall 30 of the cap 3 for breathing (see FIG. 2), and a circular peripheral wall 32 downwardly extended from the circular border of the circular top wall 30.

The stopper 4 is made of an elastic material, such as rubber, silicone rubber or flexible plastics, comprising a top flange 40 press-fitted into the cap 3 and abutted against the bottom surface of the circular top wall 30 of the cap 3 and the inner surface of the circular peripheral wall 32 of the cap 3, a first mounting through hole 41 and a second mounting through hole 42 respectively cut through opposing top and bottom ends of the stopper 4 and kept in communication with each other for the insertion of the wine-pouring tube 1 and the cap 3, and a plurality of ribs 431 extending around the periphery 43 for press-fitting into a bottleneck of a wine bottle. After installation of the wine-pouring tube 1 and the cap 3 in the stopper 4, the bottom end 22 of the breathing tube 2 suspends below the bottom end 421 of the second mounting through hole 42 at a distance.

When the bottle-top wine decanter is assembled, the user can insert the stopper 4 into a bottleneck of a wine bottle, forcing the ribs 431 in friction engagement with the inside wall of the bottleneck of the wine bottle. When the user pours the wine out of the wine bottle, the wine will flow out of the wine bottle and the wine-pouring tube 1. When the wine is flowing through the wine-pouring tube 1, it will be decanted by the alkaline filter components 5, enhancing the quality of the wine tasting.

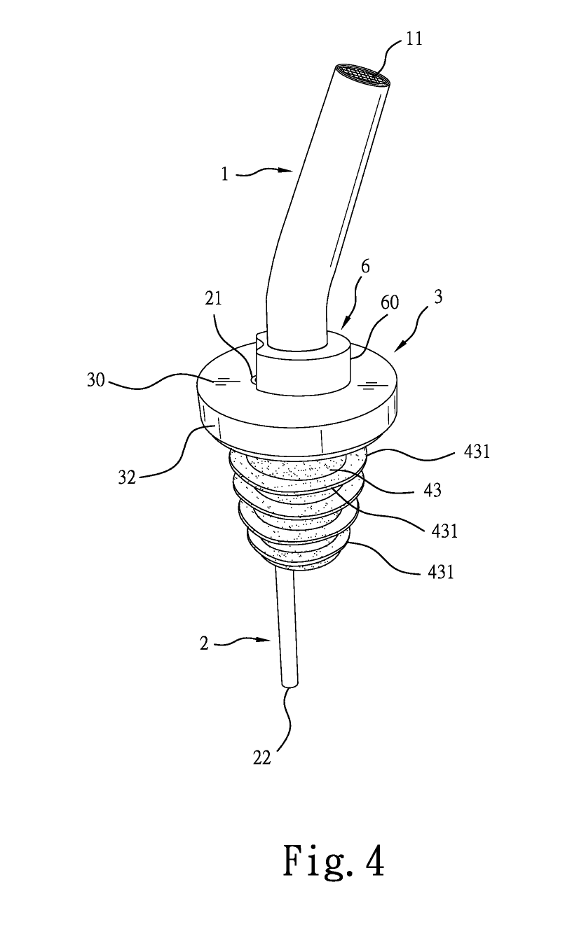

Referring to FIGS. 1 and 4 again, the bottle-top wine decanter further comprises a magnetizer 6. The magnetizer 6 comprises two magnets 61 and 62 arranged around the wine-pouring tube 1 at two opposite sides in a reversed manner, and a shell 60 covering the two magnets 61 and 62 and securing them firmly to the wine-pouring tube 1. When pouring the wine, the magnetic field induced between the two magnets 61 and 62 activates the wine, making the wine easy to drink.

In conclusion, the invention provides a bottle-top wine decanter, which has the advantages as follows:

1. When pouring a glass of wine, the wine will be decanted by the alkaline filter components 5, enhancing the quality of the wine tasting.
2. When pouring a glass of wine, the magnetizer 6 can activate the wine, making the wine easy to drink.
3. When pouring a glass of wine, the bottle-top wine decanter also works as a wine pourer, preventing splashing of the wine.
4. The circular peripheral wall 32 of the cap 3 is abutted against the periphery of the top flange 40 of the stopper 4, enhancing positioning stability.

While only one embodiment of the present invention has been shown and described, it will be understood that various modifications and changes could be made thereunto without departing from the spirit and scope of the invention disclosed.

What is claimed is:

1. A bottle-top wine decanter, comprising:
a wine-pouring tube comprising a top wire mesh filter and a bottom wire mesh filter respectively and fixedly mounted in opposing top and bottom ends thereof and a plurality of alkaline filter components set therein between said top wire mesh filter and said bottom wire mesh filter;
a breathing tube peripherally bonded to the periphery of a lower part of said wine-pouring tube;
a cap holding said wine-pouring tube and said breathing tube, said cap comprising a circular top wall, an insertion hole cut through said top wall for the mounting of said wine-pouring tube and said breathing tube in such a manner that a top end of said breathing tube is exposed outside the top wall of said cap for breathing; and
a stopper made of an elastic material, said stopper comprising a top flange press-fitted into said cap and abutted against a bottom surface of said circular top wall of said cap and an inner surface of said circular peripheral wall of said cap, a first mounting through hole and a second mounting through hole respectively cut through opposing top and bottom ends of said stopper and kept in communication with each other for receiving said wine-pouring tube and said cap, and a plurality of ribs extending around the periphery thereof.

2. The bottle-top wine decanter as claimed in claim 1, further comprising a magnetizer mounted around said wine-pouring tube and supported on the circular top wall of said cap, said magnetizer comprising two magnets reversely arranged around said wine-pouring tube and a shell covering said two magnets and fixedly bonded to said wine-pouring tube.

3. The bottle-top wine decanter as claimed in claim 1, wherein said alkaline filter components are selected from the group of alkaline ore, tourmaline and trace minerals.

4. The bottle-top wine decanter as claimed in claim 1, wherein said top wire mesh filter and said bottom wire mesh filter of said wine-pouring tube each define therein a plurality of open spaces.
